(19) United States
(12) Patent Application Publication
(10) Pub. No.: US 2026/0214180 A1
(43) Pub. Date: Jul. 23, 2026

(54) IMAGE PROCESSING DEVICE, IMAGE READING DEVICE, IMAGE FORMING APPARATUS, INFORMATION PROCESSING SYSTEM, AND IMAGE PROCESSING METHOD

(71) Applicant: Kazuki ISHIKURA, Kanagawa (JP)

(72) Inventor: Kazuki ISHIKURA, Kanagawa (JP)

(21) Appl. No.: 19/333,417

(22) Filed: Sep. 19, 2025

(30) Foreign Application Priority Data
Jan. 20, 2025 (JP) 2025-007987

(51) Int. Cl. H04N 1/60; G03G 15/22; H04N 1/00

(52) U.S. Cl. CPC H04N 1/6072; H04N 1/00806; H04N 1/00883; G03G 15/228

(57) ABSTRACT

An image processing device includes circuitry that identifies a color area included in a read visible image and having a color different from a color of a character included in the read visible image. The circuitry adjusts the color of the identified color area to be closer to a color of a background area forming a background of the character and the color area to correct the visible image to make the character included in the visible image recognizable. The circuitry further outputs the corrected visible image.

### CROSS-REFERENCE TO RELATED APPLICATION

This patent application is based on and claims priority pursuant to 35 U.S.C. § 119(a) to Japanese Patent Application No. 2025-007987, filed on Jan. 20, 2025, in the Japan Patent Office, the entire disclosure of which is hereby incorporated by reference herein.

### BACKGROUND

### Technical Field

The present disclosure relates to an image processing device, an image reading device, an image forming apparatus, an information processing system, and an image processing method.

### Related Art

There is an optical character recognition (OCR) processing technique of automatically recognizing character information in a read image.

For example, to improve the accuracy of extraction by OCR, there is disclosed a technique of identifying ruled lines in an image and converting black pixels of the ruled lines into white pixels to create an image with the ruled lines removed therefrom (an image subjected to image correction).

### SUMMARY

The present disclosure described herein provides an image processing device that includes, for example, circuitry that identifies a color area included in a read visible image and having a color different from a color of a character included in the read visible image. The circuitry adjusts the color of the identified color area to be closer to a color of a background area forming a background of the character and the color area to correct the visible image to make the character included in the visible image recognizable. The circuitry further outputs the corrected visible image.

The present disclosure described herein further provides an image reading device that includes, for example, a reading device that reads a visible image and the above-described image processing device.

The present disclosure described herein further provides an image forming apparatus that includes, for example, a reading device that reads a visible image, the above-described image processing device, and an image forming device that forms an image based on the corrected visible image output by the image processing device.

The present disclosure described herein further provides an information processing system that includes, for example, the above-described image processing device and circuitry that recognizes the character included in the corrected visible image output by the image processing device.

The present disclosure described herein further provides an image processing method executed on an image processing device. The image processing method includes, for example, identifying a color area included in a read visible image and having a color different from a color of a character included in the read visible image, adjusting the color of the identified color area to be closer to a color of a background area forming a background of the character and the color area to correct the visible image to make the character included in the visible image recognizable, and outputting the corrected visible image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an exemplary configuration of an image reading device according to a first embodiment of the present disclosure;

FIG. 2 is a diagram illustrating an exemplary configuration of control blocks of the image reading device;

FIGS. 3A and 3B are diagrams schematically illustrating a configuration for executing a process according to the first embodiment;

FIGS. 4A, 4B, and 4C are diagrams illustrating an example of a visible image according to the first embodiment;

FIGS. 5A, 5B, and 5C are diagrams illustrating another example of the visible image according to the first embodiment;

FIG. 6 is a flowchart illustrating an exemplary procedure of an image correction process according to the first embodiment;

FIG. 7 is a diagram schematically illustrating a configuration for executing an image correction process according to a second embodiment of the present disclosure;

FIG. 8 is a diagram illustrating a relationship between characters and a seal in a document such as an accounting ledger;

FIGS. 9A and 9B are diagrams schematically illustrating a configuration of a seal area identification unit according to the second embodiment;

FIGS. 10A, 10B, and 10C are diagrams illustrating an example of a visible image according to the second embodiment;

FIG. 11 is a diagram illustrating an example of a display screen of an operation panel according to the second embodiment;

FIG. 12 is a flowchart illustrating an exemplary procedure of an image correction process according to the second embodiment;

FIG. 13 is a diagram schematically illustrating a configuration for executing an image correction process according to a third embodiment of the present disclosure;

FIG. 14A is a diagram illustrating an example of a visible image;

FIG. 14B is a diagram illustrating an example of an invisible image;

FIG. 15 is a graph illustrating optical absorption characteristics of color materials;

FIGS. 16A, 16B, and 16C are diagrams illustrating an issue in identifying a color area based on a visible image and correcting the visible image;

FIGS. 17A, 17B, and 17C are diagrams illustrating an example of a visible image according to the third embodiment;

FIG. 18 is a flowchart illustrating an exemplary procedure of an image correction process according to the third embodiment;

FIG. 19 is a diagram schematically illustrating a configuration of a color area identification unit according to a fourth embodiment of the present disclosure;

FIG. 20 is a flowchart illustrating an exemplary procedure of an image correction process according to the fourth embodiment; and

FIG. 21 is a diagram illustrating an exemplary configuration of an image forming apparatus according to a fifth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the accompanying drawings, an image processing device, an image reading device, an image forming apparatus, an information processing system, and an image processing method according to embodiments of the present disclosure are described in detail below. As used herein, the singular forms “a,” “an,” and “the” are intended to include the plural forms as well, unless the context clearly indicates otherwise.

A first embodiment of the present disclosure will be described.

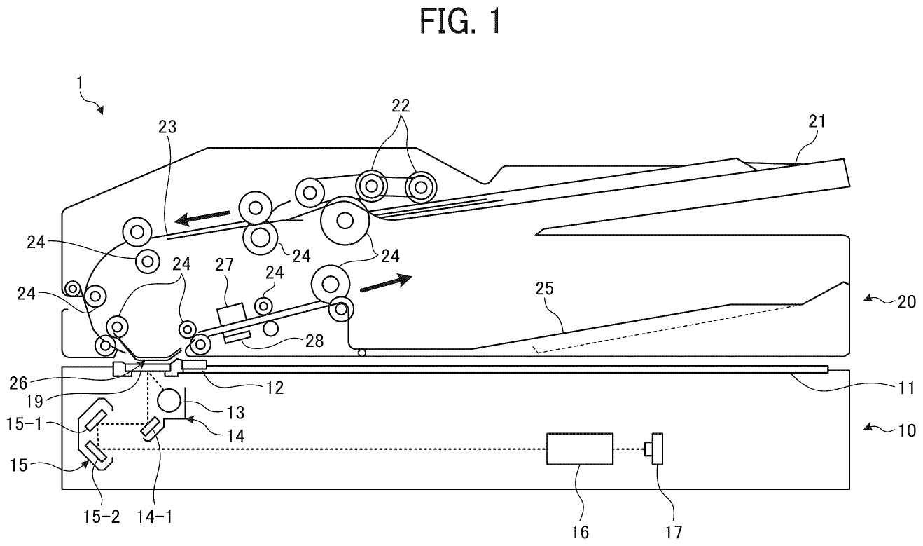

FIG. 1 is a diagram illustrating an exemplary configuration of an image reading device 1 according to the first embodiment. In the following description, an object read by the image reading device 1 may be referred to as the reading target. For example, the reading target may be printed with black characters along previously-printed colored ruled lines, or may have a seal overlapping a black area printed with black characters. The seal is a mark made by pressing a stamp. Herein, it suffices if the color of color content such as the ruled lines or the seal is different from the color of the characters; the color of the characters is not limited to black.

In the above-described example, the color content is a factor that reduces the accuracy of recognition of character information by OCR, for example (an accuracy reduction factor). For example, the accuracy reduction factor may be, but not limited to, ruled lines on a ledger document printed with characters or a seal included in a certificate, a document, or the like.

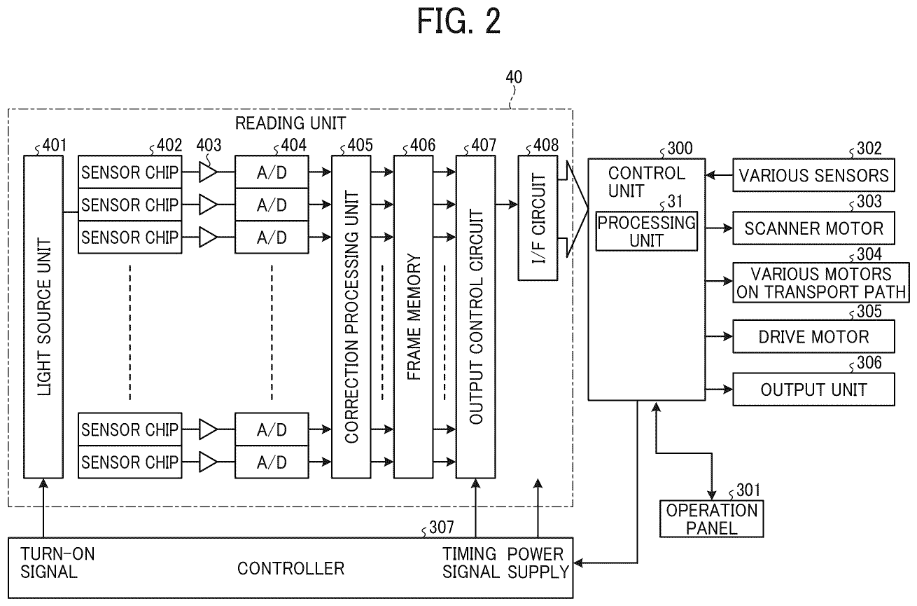

As illustrated in FIG. 1, a reading device body 10 of the image reading device 1 has an upper surface equipped with a contact glass 11. The reading device body 10 includes therein a reading unit 40 (see FIG. 2). The reading device body 10 further includes therein a light source 13, a first carriage 14, a second carriage 15, a lens unit 16, and an image sensor 17. The first carriage 14 includes the light source 13 and a mirror 14-1. The second carriage 15 includes mirrors 15-1 and 15-2. The reading device body 10 also includes a control board, which corresponds to a control unit 300 illustrated in FIG. 2 and controls the entire image reading device 1. The control unit 300 is an example of an image processing device.

The control board emits light from the light source 13 while moving the first carriage 14 and the second carriage 15. Thereby, beams of reflected light from the reading target placed on the contact glass 11 are sequentially read with the image sensor 17. The light emitted from the light source 13 and reflected by the reading target is reflected by the mirror 14-1 of the first carriage 14 and the mirrors 15-1 and 15-2 of the second carriage 15 and incident on the lens unit 16. Then, the light output from the lens unit 16 is formed into an image on the image sensor 17. The image sensor 17 receives the reflected light from the reading target and outputs an image signal. The image sensor 17 is a charge-coupled device (CCD) or complementary metal-oxide semiconductor (CMOS) image sensor, for example.

A reference white plate 12 is a member used for white correction.

The image reading device 1 illustrated in FIG. 1 is equipped with an automatic document feeder (ADF) 20. When one side of the ADF 20 is lifted, the ADF 20 opens upwards, exposing a surface of the contact glass 11. A user sets the reading target on the contact glass 11 and lowers and presses the ADF 20 against the back surface of the reading target to press the reading target onto the surface of the contact glass 11. Then, in response to pressing of a button for starting a scanning process, for example, the first carriage 14 and the second carriage 15 are driven to move in the main scanning direction and the sub-scanning direction to read the entire reading target.

As well as the method of reading the reading target set on the contact glass 11, the following method may be used to read the reading target. The ADF 20 may read the reading target with a sheet-through method. In the ADF 20, pickup rollers 22 separate a reading target from a stack of reading targets in a tray 21 of the ADF 20. The ADF 20 controls components such as various transport rollers 24 to read one side or both sides of the reading target transported on a transport path 23 and eject the reading target onto a sheet ejection tray 25.

The ADF 20 uses a reading window 19 to read the reading target with the sheet-through method. In this example, the first carriage 14 and the second carriage 15 are moved to and fixed at respective particular home positions. When the reading target passes the space between the reading window 19 and a background unit 26, the front side of the reading target facing the reading window 19 is irradiated with the light from the light source 13 to read an image. The reading window 19 is a slit-like opening for the reading. The background unit 26 is a background member. The reading window 19 may be provided separately from the contact glass 11 or as a part of the contact glass 11.

To read both sides of the reading target with the ADF 20, a reading module 27 provided to face the back side of the reading target reads the back side after the reading target passes the reading window 19. The reading module 27 includes an irradiation unit including a light source and a contact-type image sensor. The contact-type image sensor reads the light directed to and reflected by the back side of the reading target. A background member 28 is a density reference member.

A configuration of control blocks of the image reading device 1 will be described.

FIG. 2 is a diagram illustrating an exemplary configuration of the control blocks of the image reading device 1. As illustrated in FIG. 2, the image reading device 1 includes a control unit 300, an operation panel 301, various sensors 302, a scanner motor 303, various motors 304 on a transport path, a drive motor 305, an output unit 306, and a reading unit 40. Various other control targets are also connected to the control blocks. The various sensors 302 are sensors that detect the reading target. The scanner motor 303 is a motor that drives the first carriage 14 and the second carriage 15 of the reading device body 10. The various motors 304 on the transport path are various motors provided in the ADF 20. The output unit 306 corresponds to an output interface for outputting image data to an external device. The output interface may be an interface to connect to a device such as a universal serial bus (USB) device or a communication interface to connect to a network.

The operation panel 301 is a liquid crystal display device with a touch panel, for example. The operation panel 301 receives an input operation to perform various settings or execute reading (start scanning) from the user via an operation button or touch input, for example, and transmits a corresponding operation signal to the control unit 300. The operation panel 301 further displays various display information from the control unit 300 on a display screen.

The reading unit 40 includes a light source unit 401, sensor chips 402, amplifiers 403, analog-to-digital (A/D) converters 404, a correction processing unit 405, a frame memory 406, an output control circuit 407, and an interface (I/F) circuit 408. The reading unit 40 outputs a visible image, which is obtained by reading the reading target, frame by frame to the control unit 300 from the output control circuit 407 via the I/F circuit 408. The sensor chips 402 are pixel sensors of the image sensor 17. The light source unit 401 corresponds to the light source 13. The visible image is an image captured by irradiating the reading target with visible light and receiving the reflected light from the reading target.

The reading unit 40 is driven by a controller 307. For example, the reading unit 40 turns on the light source unit 401 based on a turn-on signal from the controller 307 to irradiate the reading target with light at a set time. The reading unit 40 further converts the light from the reading target, which is formed into an image on a sensor surface of the image sensor 17, into electrical signals with the sensor chips 402 and outputs the electrical signals.

In the reading unit 40, the amplifiers 403 amplify pixel signals output from the sensor chips 402, and the A/D converters 404 convert the pixel signals from analog signal to digital signal to output level signals of pixels. The correction processing unit 405 performs an image correction process on the output signals from the pixels. For example, the correction processing unit 405 performs correction such as shading correction on the output signals from the pixels.

After the correction process, the data of the read image is accumulated in the frame memory 406, and the accumulated data of the read image is transferred to the control unit 300 via the output control circuit 407 and the I/F circuit 408.

The control unit 300 includes a central processing unit (CPU) and a memory. The CPU controls the entire image reading device 1 to read the reading target or execute the image correction process of the present embodiment on the read visible image.

The control unit 300 further includes a processing unit 31. The processing unit 31 may be implemented by the CPU executing a particular program. The processing unit 31 may also be implemented by hardware such as an application specific integrated circuit (ASIC).

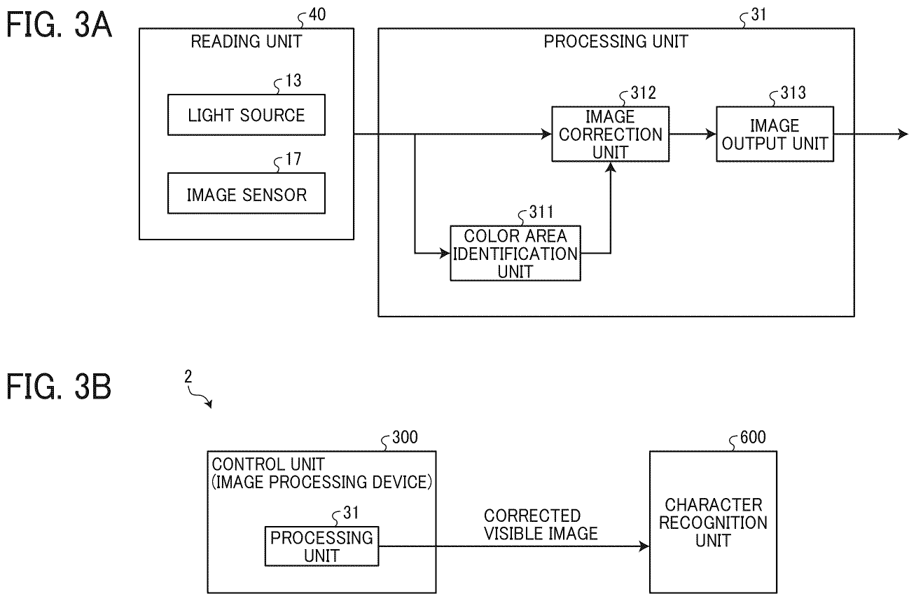

FIGS. 3A and 3B are diagrams schematically illustrating a configuration for executing a process according to the first embodiment. FIG. 3A schematically illustrates a configuration for executing an image correction process. The reading unit 40 in FIG. 3A includes the light source 13 and the image sensor 17 described above with FIGS. 1 and 2. The reading unit 40 irradiates the reading target with the light from the light source 13, receives the reflected light from the reading target with the image sensor 17, and outputs a visible image (e.g., a red-green-blue (RGB) image).

As illustrated in FIG. 3A, the processing unit 31 includes a color area identification unit 311, an image correction unit 312, and an image output unit 313.

The color area identification unit 311 identifies a color area with a color different from the color of a character included in the read visible image. For example, the color area identification unit 311 identifies an area with a particular color as the color area. Herein, the particular color is the color of color content, and is a previously set color such as the color of ruled lines or a seal (e.g., red or light blue).

The image correction unit 312 corrects the visible image by adjusting the color of the color area identified by the color area identification unit 311 to be closer to the color of an area forming the background of the character and the color area (the background area). The image correction unit 312 thus performs image correction to make the character included in the visible image recognizable.

The image output unit 313 outputs the corrected visible image corrected by the image correction unit 312. FIG. 3B schematically illustrates a configuration for executing a character recognition process on the corrected visible image. As illustrated in FIG. 3B, an information processing system 2 includes the control unit 300 (the image processing device) including the processing unit 31 and a character recognition unit 600. For example, the character recognition unit 600 is a personal computer (PC) installed with software such as OCR software. The corrected visible image output from the control unit 300 is binarized with the software such as the OCR software installed in the character recognition unit 600 to extract a character area and recognize character information.

The software such as the OCR software is not limited to the software installed in the character recognition unit 600. For example, the software such as the OCR software may be any software for character recognition using the image output by the control unit 300, such as software stored in a cloud environment.

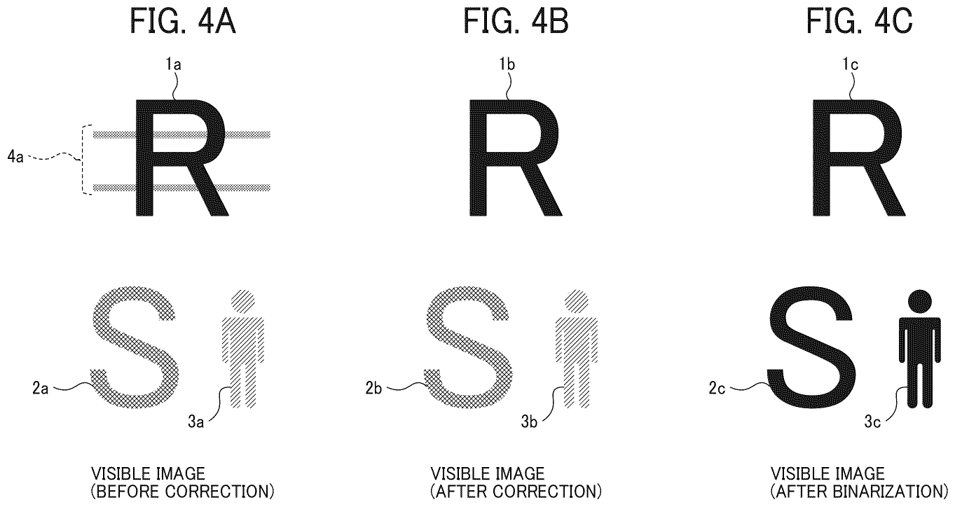

FIGS. 4A, 4B, and 4C are diagrams illustrating an example of a visible image according to the first embodiment. FIG. 4A illustrates an example of a read visible image (a visible image before being corrected). In this example, the visible image before being corrected includes characters 1a and 2a and a pictorial pattern 3a, which are printed on a sheet with ruled lines 4a. It is assumed here that the color of the character 1a is black, and that the color of the ruled lines 4a is red. It is also assumed that the color of the character 2a is green, and that the color of the pictorial pattern 3a is blue. Further, it is assumed that the color of a background area behind characters and pictorial patterns is white, and that the particular color different from the color of the characters and identified by the color area identification unit 311 is red.

If the visible image of FIG. 4A is input, the color area identification unit 311 identifies the area of the ruled lines 4a as the color area with a color different from the color of the character 1a. The image correction unit 312 adjusts the color of the identified color area to be closer to the color of the background area to correct the visible image. FIG. 4B illustrates an example of an image obtained through the correction of the image of FIG. 4A by the image correction unit 312. In this example, the color of the area of the ruled lines 4a is corrected to the color of the background area to remove the ruled lines 4a from the visible image. Characters 1b and 2b and a pictorial pattern 3b, on the other hand, are not corrected, and thus are identical with the characters 1a and 2a and the pictorial pattern 3a of FIG. 4A.

FIG. 4C illustrates an example of an image obtained by binarizing the image of FIG. 4B. In this example, the visible image with the ruled lines 4a removed therefrom is converted into binary values of black and white to obtain an image suitable for the recognition of the character information. In the first embodiment, the color content is thus removed while the color information of areas other than the color content with the particular color is retained. Therefore, colored characters and pictorial patterns are readily used, and an image suitable for a later process of recognizing the character information is obtained. Herein, the binarization is not limited to the process of converting the image into the binary values of black and white, and may be any process suitable for the software such as the OCR software to recognize the character information.

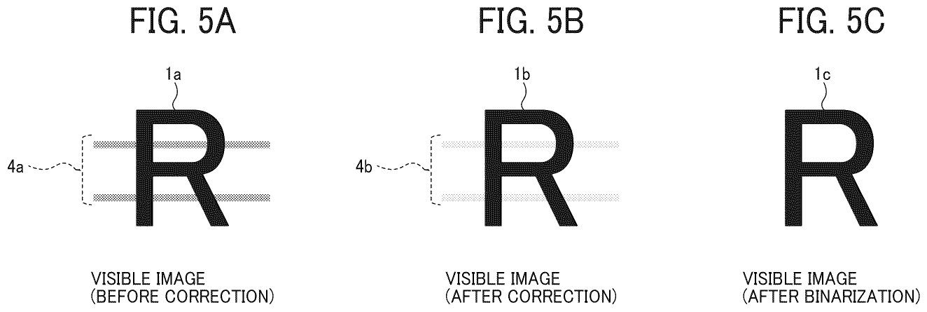

FIGS. 5A, 5B, and 5C are diagrams illustrating another example of the visible image according to the first embodiment. The character 1a and the ruled lines 4a in FIG. 5A are identical with those in FIG. 4A. If the visible image of FIG. 5A is input, the color area identification unit 311 identifies the area of the ruled lines 4a as the color area. The image correction unit 312 adjusts the color of the identified color area to be closer to the color of the background area to correct the visible image.

FIG. 5B illustrates an example of an image obtained through the correction of the image of FIG. 5A by the image correction unit 312. In this example, the lightness of the color of the area of the ruled lines 4 is adjusted to be closer to the lightness of the color of the background area (the lightness of white color). Thereby, the image is corrected to have ruled lines 4b lightened in color.

FIG. 5C illustrates an example of an image obtained by binarizing the image of FIG. 5B. In this example, the ruled lines 4b are removed through the binarization to obtain an image suitable for the recognition of the character information. Due to an amendment to the Law on Book and Record Keeping through Electronic Methods, for example, recent years have seen an increasing demand for the image of a document such as a ledger document read for the OCR process to be stored as the original. In the first embodiment, the lightness of the color of the ruled lines 4b is adjusted to be closer to the lightness of the color of the background area without the removal of the ruled lines 4b, as illustrated in FIG. 5B. Consequently, the image correction suitable for the later process of recognizing the character information is performed, while the originality of the read image is retained.

The color of the background area may be other than white. For example, the image may be printed with characters and color content of high lightness against a dark-colored background. In this case, too, the image correction unit 312 performs the correction to adjust the lightness of the color of the identified color area to be closer to the lightness of the color of the background area to eliminate the accuracy reduction factor due to the color content, to thereby obtain a corrected image suitable for the recognition of the character information.

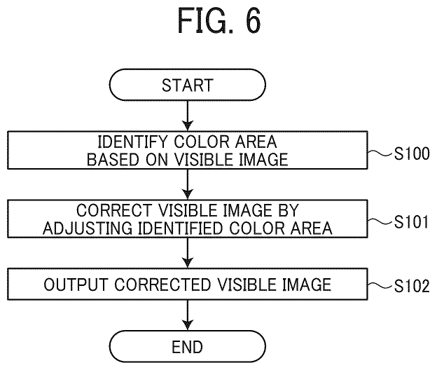

FIG. 6 is a flowchart illustrating an exemplary procedure of an image correction process according to the first embodiment. The color area identification unit 311 first identifies the color area based on the visible image (step S100). More specifically, the color area identification unit 311 identifies an area with a particular color as the color area.

The image correction unit 312 then corrects the visible image by adjusting the identified color area (step S101). More specifically, the image correction unit 312 corrects the visible image by adjusting the color of the identified color area to be closer to the color of the background area. Then, the image output unit 313 outputs the corrected visible image (step S102).

According to the first embodiment, the color of the identified color area is thus adjusted to be closer to the color of the background area. Consequently, the image correction suitable for the recognition of the character information is performed even if a character overlaps color content different in color from the character.

A second embodiment of the present disclosure will be described.

In the second embodiment, the area of a seal is identified as the color area included in the visible image. The following description of the second embodiment will focus on differences from the first embodiment, with the description of similarities to the first embodiment being omitted.

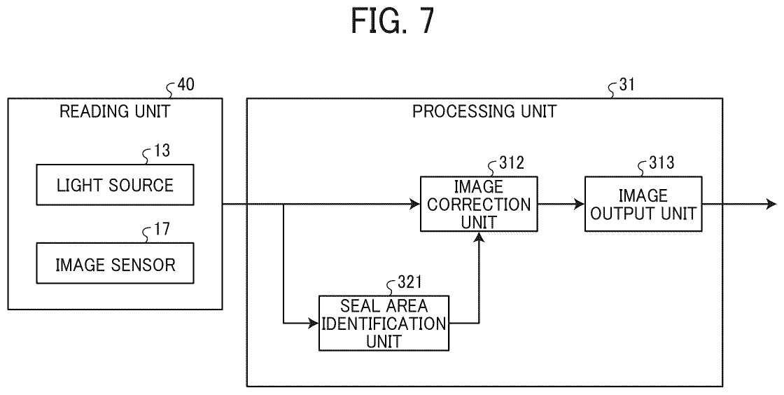

FIG. 7 is a diagram schematically illustrating a configuration for executing an image correction process according to the second embodiment. The configuration of FIG. 7 is different from the configuration of FIG. 3A in that the processing unit 31 includes a seal area identification unit 321 as the color area identification unit 311.

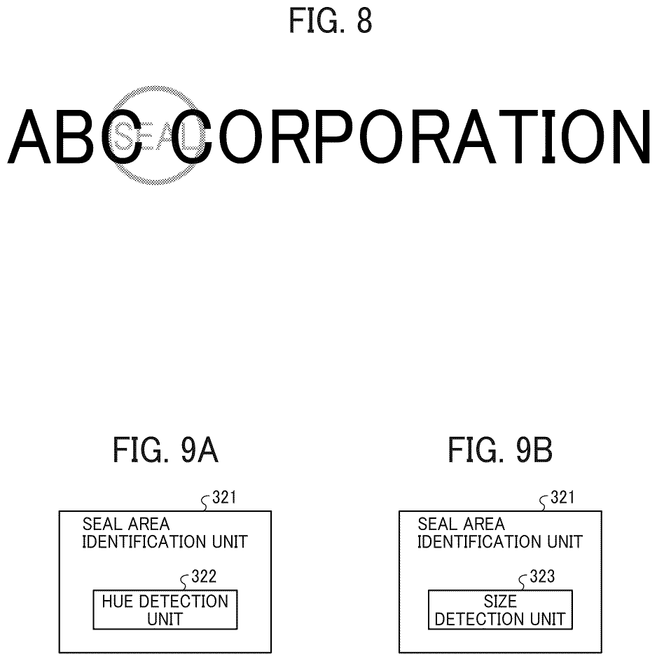

The seal area identification unit 321 identifies the area of a seal included in the visible image as the color area. FIG. 8 is a diagram illustrating a relationship between characters and a seal in a document such as an accounting ledger. As illustrated in FIG. 8, the seal in the document such as the accounting ledger has two characteristics: a reddish inkpad is used for the seal, and the seal is larger in size than each character.

In view of these characteristics, the seal area identification unit 321 of the second embodiment has a configuration as illustrated in FIG. 9A or 9B. FIGS. 9A and 9B are diagrams schematically illustrating a configuration of the seal area identification unit 321. In FIG. 9A, the seal area identification unit 321 includes a hue detection unit 322. In FIG. 9B, the seal area identification unit 321 includes a size detection unit 323.

The hue detection unit 322 identifies an area with a particular color as the area of a seal. Herein, the particular color is a color corresponding to the reddish inkpad, such as a color with the red (R), red-yellow (RY), or yellow (Y) hue in the Munsell color system, for example. With the hue detection unit 322, the seal area identification unit 321 identifies the area of the seal as the color area, preventing a character with a non-reddish color from being erroneously corrected. In the above-described example, the hue of the identified color area may not be strictly identical with the R, RY, or Y hue. For example, the hue detection unit 322 may identify an area of a color with a hue close to the R, RY, or Y hue as the area of the seal.

The size detection unit 323 identifies an area formed with a particular color and a particular size as the area of the seal. The particular size is equal to or greater than 5 mm (approximately 118 pixels at 600 dots per inch (dpi)), for example. Thereby, an area with the R, RY, or Y hue and the size of 5 mm or greater, for example, is identified as the area of the seal. The particular size may be defined with a minimum size alone, or may be defined with a minimum size and a maximum size.

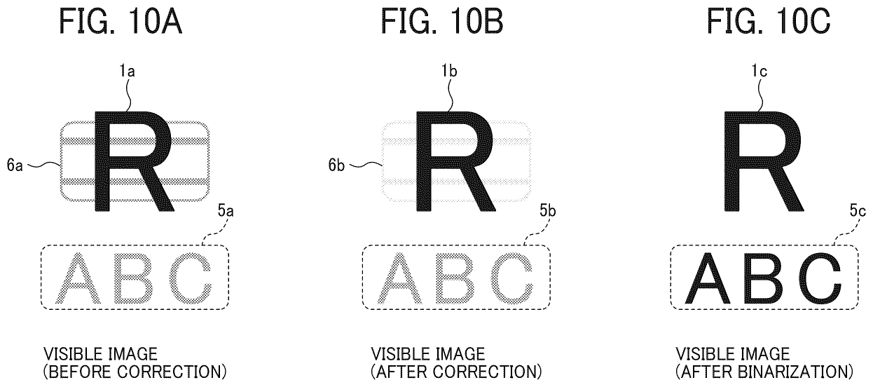

FIGS. 10A, 10B, and 10C are diagrams illustrating an example of a visible image according to the second embodiment. FIG. 10A illustrates an example of a visible image before being corrected. The visible image includes the black character 1a overlapping a red seal 6a and a red character string 5a not overlapping a seal. In this example, the size detection unit 323 identifies the area of the seal 6a, which is wider than the character 1a in the horizontal direction, as the color area, and the image correction unit 312 corrects the visible mage to lighten the color of the seal 6a, as in a seal 6b of FIG. 10B. The character string 5a has a color similar to the color of the seal 6a, but the size of each of characters in the character string 5a is less than the particular size. Therefore, the character string 5a is not identified as the color area. Consequently, the color density of the character string 5a is retained after the image correction, as in a character string 5b of FIG. 10B.

FIG. 10C illustrates an example of an image obtained by binarizing the image of FIG. 10B. In this example, the seal 6b alone is removed through the binarization to obtain an image suitable for the recognition of the character information.

The above-described particular color is illustrative, and thus a color other than the above-described color may be used. The color hue of the seal in the visible image changes due to the influence of the type of inkpad or the reading device, for example. Further, the color hue of the seal may change depending on factors such as the field where the accounting ledger is used and the trends of the times. Therefore, the particular color may be set with the operation panel 301 to adjust to the color of the seal used by the user.

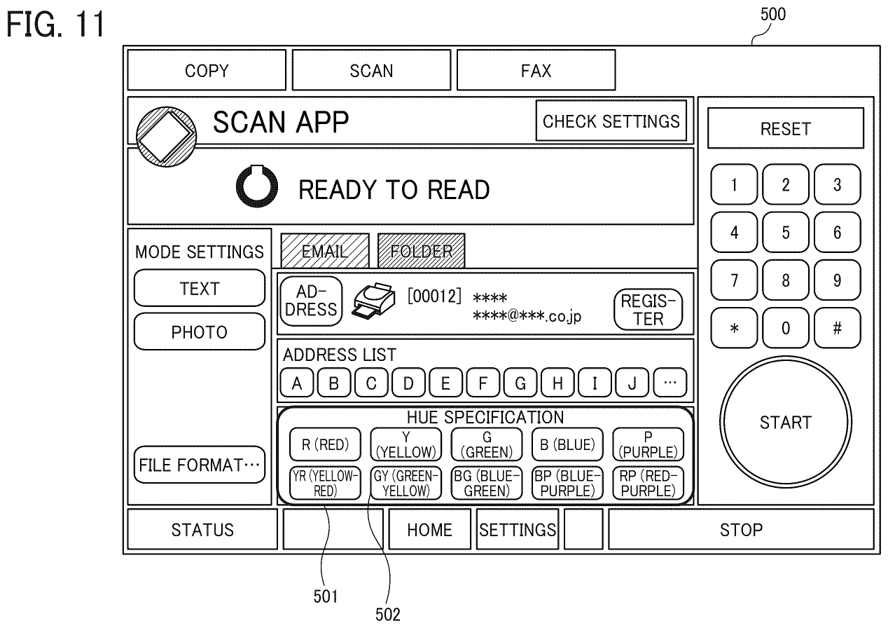

FIG. 11 is a diagram illustrating an example of the display screen of the operation panel 301. As illustrated in FIG. 11, a display screen 500 includes a setting unit 501. In this example, the setting unit 501 includes ten hue buttons 502 for specifying the hue.

The user may touch one or more of the hue buttons 502 corresponding to a hue to set, to thereby set a desired hue as the hue of the particular color. For example, if a blue-purplish seal is used, the user may set “B (BLUE),” “BP (BLUE-PURPLE),” and “P (PURPLE)” with the setting unit 501 to perform image correction by identifying an area with any of these hues as the area of the seal.

The method of displaying the setting unit 501 illustrated in FIG. 11 is illustrative, and thus a different display method may be used. For example, the setting unit 501 may be displayed to allow the user to specify the particular color with a specific color name. Further, the number of specifiable hues may be more or less than ten.

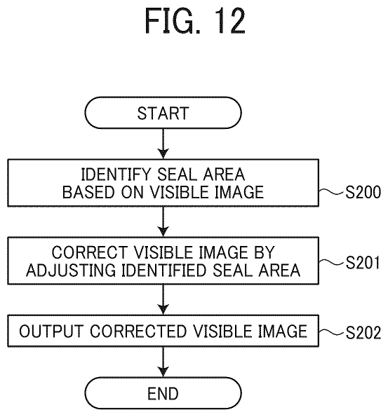

FIG. 12 is a flowchart illustrating an exemplary procedure of an image correction process according to the second embodiment. The procedure of FIG. 12 is different from the procedure of FIG. 6 in that the color area is replaced by the area of the seal (the seal area) in steps S200 and S201. The process of step S202 is similar to that of step S102 in FIG. 6, and thus the description thereof will be omitted.

The seal area identification unit 321 identifies the seal area as the color area based on the visible image (step S200). Then, the image correction unit 312 corrects the visible image by adjusting the identified seal area (color area) (step S201). More specifically, the image correction unit 312 corrects the visible image by adjusting the color of the seal area to be closer to the color of the background area.

According to the second embodiment, the area of the seal is thus identified as the color area, thereby enabling the image correction suitable for the recognition of the character information.

The color setting by the setting unit 501 may be used in the setting of the particular color according to the first embodiment. In this case, the color used in the ruled lines may be set as the particular color, for example, to perform image correction that lightens the color of the area of the ruled lines.

A third embodiment of the present disclosure will be described.

The third embodiment is different from the first and second embodiments in that the reading unit 40 includes a visible image reading unit 40-1 and an invisible image reading unit 40-2. The following description of the third embodiment will focus on differences from the first and second embodiments, with the description of similarities to the first and second embodiments being omitted.

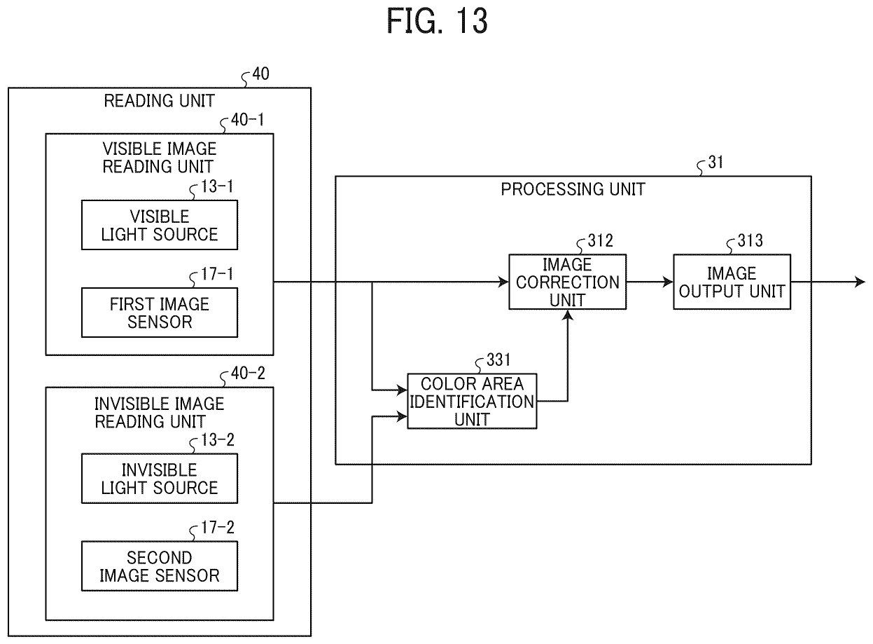

FIG. 13 is a diagram schematically illustrating a configuration for executing an image correction process according to the third embodiment. The configuration of FIG. 13 is different from the configuration of FIG. 3A in that the reading unit 40 includes the visible image reading unit 40-1 and the invisible image reading unit 40-2, and that a color area identification unit 331 of the processing unit 31 identifies the color area by using an image read by the invisible image reading unit 40-2 in addition to an image read by the visible image reading unit 40-1. The color area identification unit 331 may be a seal area identification unit that identifies the seal area.

The visible image reading unit 40-1 includes a visible light source 13-1 and a first image sensor 17-1 that receives reflected light of visible light directed to the reading target and outputs an image. The invisible image reading unit 40-2 includes an invisible light source 13-2 and a second image sensor 17-2 that receives reflected light of infrared light directed to the reading target and outputs an image. The second image sensor 17-2 is a sensor sensitive to invisible light. The second image sensor 17-2 has peak sensitivity around 850 nm, for example. In the third embodiment, the image output from the visible image reading unit 40-1 will be referred to as the visible image, and the image output from the invisible image reading unit 40-2 will be referred to as the invisible image.

In the reading unit 40 of FIG. 13, the visible light source 13-1 and the invisible light source 13-2 are provided separately. Alternatively, the reading unit 40 may be configured to emit the visible light and the invisible light from a single light source. Further, in the reading unit 40 of FIG. 13, the first image sensor 17-1 and the second image sensor 17-2 are provided separately. Alternatively, the reading unit 40 may be configured to output the visible image and the invisible image from a single image sensor.

The visible image reading unit 40-1 irradiates the reading target with the light from the visible light source 13-1, receives the reflected light from the reading target with the first image sensor 17-1, and outputs the visible image (e.g., RGB image). The invisible image reading unit 40-2 irradiates the same reading target with the light from the invisible light source 13-2, receives the reflected light from the reading target with the second image sensor 17-2, and outputs the invisible image (e.g., near-infrared (NIR) image).

The reading unit 40 may simultaneously read the visible image and the invisible image from the same reading target. If the reading target is the same, the reading unit 40 does not need to read the visible image and the invisible image simultaneously. The reading unit 40 may read the visible image and the invisible image at different times, as long as the position of the reading target is the same.

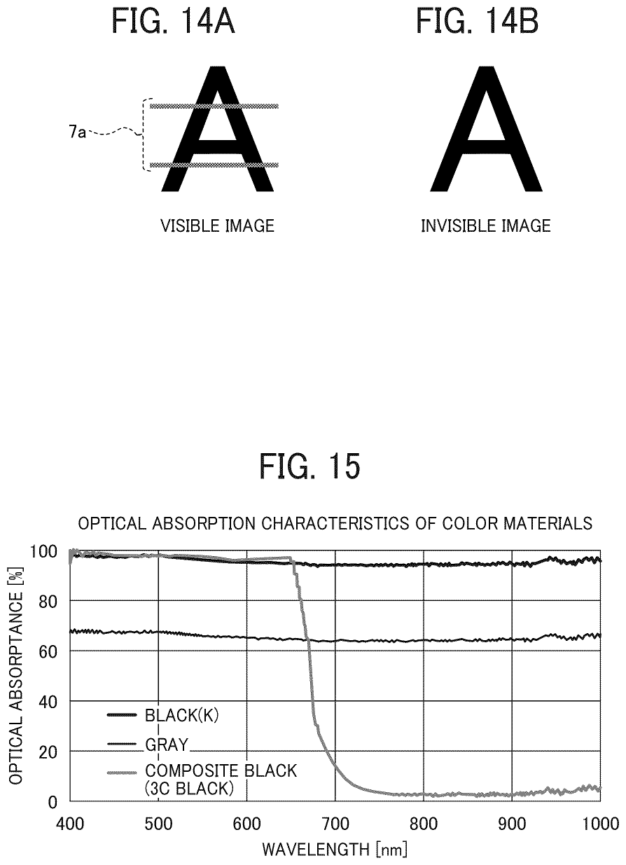

FIG. 14A is a diagram illustrating an example of the visible image. FIG. 14B is a diagram illustrating an example of the invisible image. FIG. 14A illustrates an example of a visible image obtained by reading a reading target, which is printed with a black character and red ruled lines 7a overlapping each other, with the visible image reading unit 40-1. FIG. 14B illustrates an example of an invisible image obtained by reading the same reading target as that of FIG. 14A with the invisible image reading unit 40-2.

Black ink, black toner, or black pencil used in the black character contains carbon. Carbon is a color material with a characteristic of absorbing light in the visible range and the infrared range. Therefore, what is printed with this color material is read as black in both the visible range and the infrared range. Color ink or cyan-magenta-yellow (CMY) color toner, on the other hand, is a color material with a characteristic of transmitting light in the infrared range.

FIG. 15 is a graph illustrating optical absorption characteristics of color materials. In the graph of FIG. 15, the horizontal axis represents the wavelength of light, and the vertical axis represents the absorptance of light. In FIG. 15, “BLACK” refers to a color material containing carbon, as described above, and “GRAY” refers to a color material forming gray ink (or black toner used in printing by thinning out print data). Further, “COMPOSITE BLACK” refers to a color material created by mixing the C, M, and Y colors (hereinafter also referred to as the 3C black). The 3C black absorbs light in the visible range and transmits light in the near-infrared range. In the near-infrared range, therefore, the 3C black is read as white of white sheet.

As illustrated in FIG. 14A, the image read in the visible range is an image (visible image) with the black character and the color content (the ruled lines 7a) coexisting, more specifically, with the black character and the ruled lines 7a overlapping each other.

The image read in the infrared range, on the other hand, is an image (invisible image) with the black character alone, as illustrated in FIG. 14B.

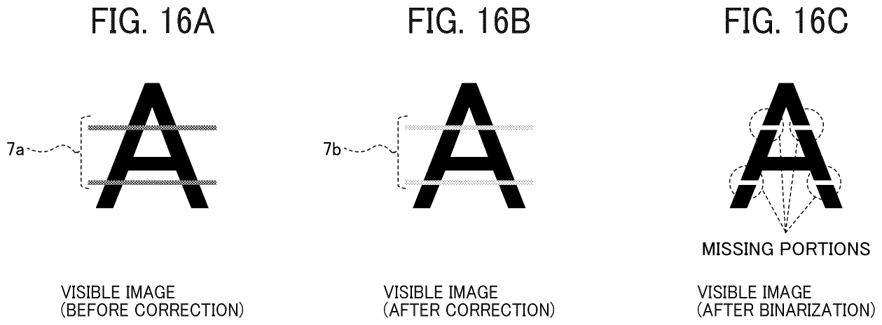

FIGS. 16A, 16B, and 16C are diagrams illustrating an issue in identifying the color area based on the visible image and correcting the visible image. FIG. 16A illustrates the same visible image as that of FIG. 14A. FIG. 16B illustrates a visible image obtained through image correction by identifying the color area based on the visible image of FIG. 16A, according to a comparative example. FIG. 16C illustrates a visible image obtained by binarizing the image of FIG. 16B, according to the comparative example. In this example, the ruled lines 7a overlapping the black character are identified as the color area. In the corrected visible image, therefore, the color of overlapping portions of the black character and the ruled lines 7a is lightened by the image correction. Consequently, the black character has missing portions as illustrated in FIG. 16C after the removal of ruled lines 7b through the binarization.

Such an issue occurs when, for example, a character and color content overlap in the print position, and the color of the color content is printed dark depending on the combination of the color material used in the character and the color material used in the color content.

To address the above-described issue, the color area identification unit 331 of the third embodiment identifies the color area by using the visible image and the invisible image. An operation of the color area identification unit 331 will be described with reference to FIGS. 14A and 14B again.

The color area identification unit 331 extracts a candidate for the color area from the visible image. In the example of FIG. 14A, the area of the ruled lines 7a is extracted as the candidate for the color area. The color area identification unit 331 further extracts a character area from the invisible image. In the example of FIG. 14B, an area read as black is extracted as the character area. The color area identification unit 331 then identifies portions of the extracted candidate for the color area excluding the extracted character area as the color area.

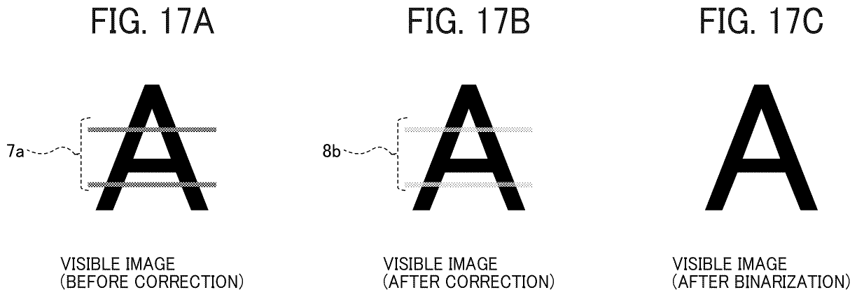

FIGS. 17A, 17B, and 17C are diagrams illustrating an example of a visible image according to the third embodiment. FIG. 17A illustrates the same visible image as that of FIG. 14A. FIG. 17B illustrates a visible image obtained by performing image correction with the color area identified by the color area identification unit 331. FIG. 17C illustrates a visible image obtained by binarizing the image of FIG. 17B.

As described above, the color area identification unit 331 identifies the portions of the candidate for the color area excluding the character area as the color area. In the corrected visible image, therefore, the correction to lighten the color is limited to portions of ruled lines 8b excluding the character area. The other portions of the ruled lines 8b not subjected to the correction and retaining the original color are converted into black through the binarization. Consequently, a black character without missing portions is obtained, as illustrated in FIG. 17C.

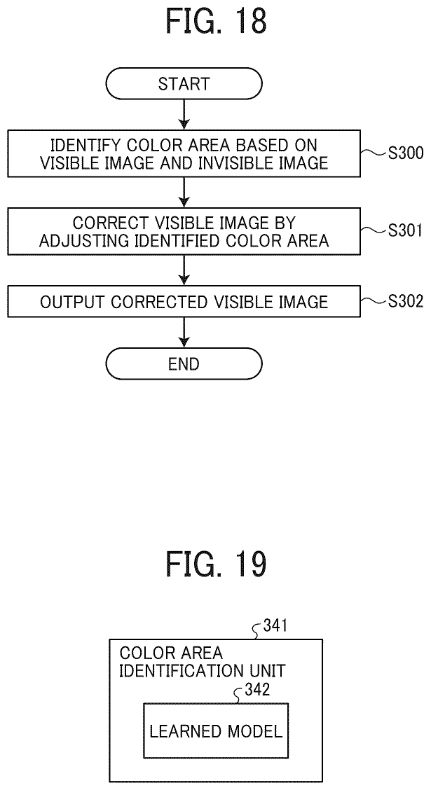

FIG. 18 is a flowchart illustrating an exemplary procedure of an image correction process according to the third embodiment. The procedure of FIG. 18 is different from the procedure of FIG. 6 in that the color area is identified based on the visible image and the invisible image at step S300. The processes of steps S301 and S302 are similar to those of steps S101 and S102 in FIG. 6, and thus the description thereof will be omitted.

The color area identification unit 331 identifies the color area based on the visible image and the invisible image (step S300). More specifically, the color area identification unit 331 identifies, as the color area, portions of the candidate for the color area extracted from the visible image and excluding the character area extracted from the invisible image (the black area read by the invisible image reading unit 40-2). The character area may be the image of other than a character (e.g., an image to be recognized by the OCR software, such as the image of a symbol).

According to the third embodiment, the color area is thus identified based on the visible image and the invisible image. Consequently, the image correction suitable for the recognition of the character information is performed even if the character area includes the color of the color content.

Similarly as in the second embodiment, the color area identification unit 331 may include a hue detection unit or a size detection unit to identify the seal area. In this case, the color area identification unit 331 extracts a candidate for the seal area from the visible image, and identifies, as the seal area, portions of the candidate for the seal area excluding the character area extracted from the invisible image.

A fourth embodiment of the present disclosure will be described.

The fourth embodiment uses a learned artificial intelligence (AI) model to identify the color area. The following description of the fourth embodiment will focus on differences from the first to third embodiments, with the description of similarities to the first to third embodiments being omitted.

FIG. 19 is a diagram schematically illustrating a configuration of a color area identification unit 341 according to the fourth embodiment. The fourth embodiment is different from the first to third embodiments in that the processing unit 31 includes the color area identification unit 341 in place of the color area identification unit 311, the seal area identification unit 321, or the color area identification unit 331.

As illustrated in FIG. 19, the color area identification unit 341 includes a learned model 342. The learned model 342 is a machine-learned AI model (machine-learned model) that has machine-learned with learning data including a visible image read from a print of color content and character information overlapping each other and a visible image read from a print of color content alone. The former visible image of the learning data is an example of a visible image including a color area and a character, and the latter visible image of the learning data is an example of information of the color area. The AI model is an example of a learned model.

Herein, machine learning refers to a technology for causing a computer to acquire learning ability comparable to human learning ability. According to the technology, the computer autonomously generates, from previously captured learning data, algorithms for making decisions such as data identification, and makes predictions by applying the algorithms to new data. The learning method for machine learning may be any of supervised learning, unsupervised learning, semi-supervised learning, reinforcement learning, and deep learning, or may be a combination of two or more of these learning methods. The learning method for machine learning is not limited to a particular method.

The color content is a seal, for example. The seal has various types, but the seal used in a document such as a ledger used by the user may be limited to a particular type. For example, in the accounting department of a company, it may be desired to improve the accuracy in recognizing a company name printed on an invoice with a seal. In this case, the AI model may be caused to machine-learn images of seals of regular clients of the company as the learning data. Thereby, the accuracy of identification of the seal area by the color area identification unit 341 is improved, enabling image correction suitable for the recognition of the character information by OCR, for example.

The color content may be other than the seal. For example, the AI model may be caused to machine-learn ruled lines and colored areas included in the formats of frequently used documents such as ledgers as the color content.

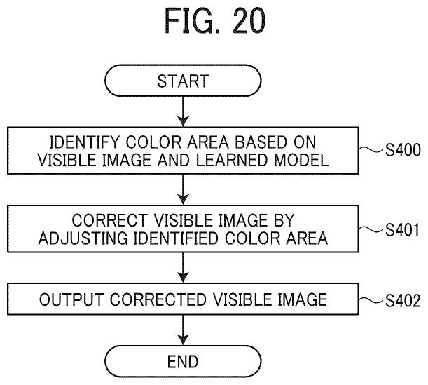

FIG. 20 is a flowchart illustrating an exemplary procedure of an image correction process according to the fourth embodiment. The procedure of FIG. 20 is different from the procedure of FIG. 6 in that the learned model 342 is additionally used at step S400. The processes of steps S401 and S402 are similar to those of steps S101 and S102 in FIG. 6, and thus the description thereof will be omitted.

The color area identification unit 341 identifies the color area based on the visible image and the learned model 342 (step S400). More specifically, the color area identification unit 341 inputs a read visible image to the learned model 342 and identifies the color area with an output from the learned model 342. The color area identification unit 341 identifies the color area with a method such as determining the output from the learned model 342 as the color area or converting the output from the learned model 342 to obtain the color area.

According to the fourth embodiment, the AI model is thus additionally used to improve the accuracy in identifying the color area. Consequently, the image correction suitable for the recognition of the character information is performed.

A fifth embodiment of the present disclosure will be described.

In the fifth embodiment, the image reading device 1 of the first to fourth embodiments is included in an image forming apparatus. The following description of the fifth embodiment will focus on differences from the first to fourth embodiments, with the description of similarities to the first to fourth embodiments being omitted.

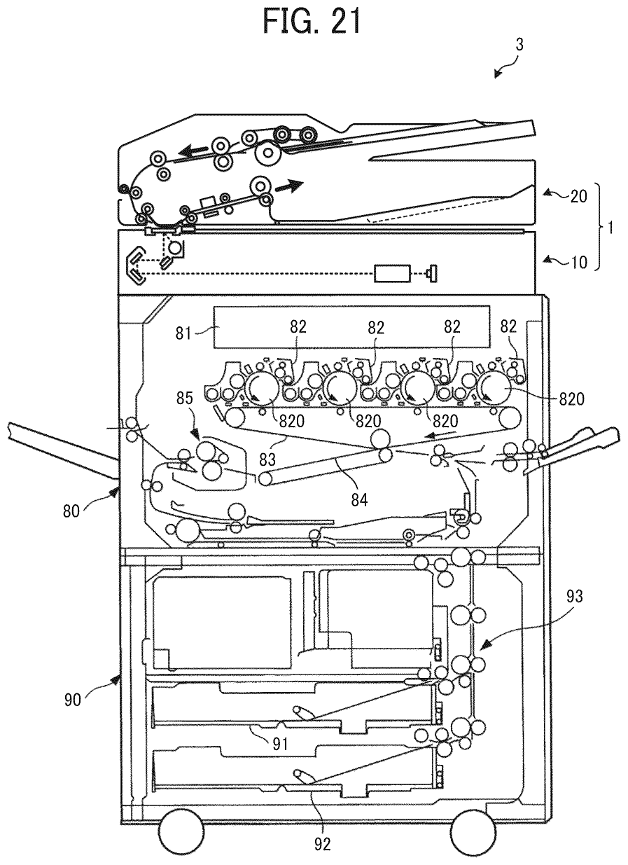

FIG. 21 is a diagram illustrating an exemplary configuration of an image forming apparatus according to the fifth embodiment. FIG. 21 illustrates an image forming apparatus 3 as an example. The image forming apparatus 3 is commonly called a multifunction machine or a multifunction peripheral (MFP). The image forming apparatus 3 illustrated in FIG. 21 has an upper portion equipped with the image reading device 1 (the reading device body 10 and the ADF 20). The configuration of the image reading device 1 is the same as described above in the first embodiment, and thus a detailed description thereof will be omitted here.

The image forming apparatus 3 illustrated in FIG. 21 includes an image forming unit 80 and a sheet feeding unit 90 under the reading device body 10.

The image forming unit 80 prints a read image read by the reading device body 10 on a recording sheet, which is an example of a recording medium. The read image is a visible image or an invisible image.

The image forming unit 80 includes an optical writing device 81, tandem-type imaging units (for yellow (Y), magenta (M), cyan (C), and black (K)) 82, an intermediate transfer belt 83, and a second transfer belt 84, for example. In the image forming unit 80, the optical writing device 81 writes images of a print target on photoconductor drums 820 of the imaging units 82, and toner images of respective plates are transferred onto the intermediate transfer belt 83 from the photoconductor drums 820. The K plate is formed with K toner containing carbon black.

The imaging units (Y, M, C and K) 82 include four rotatable photoconductor drums (Y, M, C and K) 820. Each of the photoconductor drums 820 is surrounded by imaging components including a charging roller, a development device, a first transfer roller, a cleaner unit, and a discharger. With the imaging components operating around the photoconductor drums 820 in a particular imaging process, images are formed on the photoconductor drums 820. The images formed on the photoconductor drums 820 are then transferred onto the intermediate transfer belt 83 as toner images by the first transfer rollers.

The intermediate transfer belt 83 is stretched by a drive roller and a driven roller and disposed in respective nips between the photoconductor drums 820 and the first transfer rollers. With the intermediate transfer belt 83 rotating, the toner images first-transferred to the intermediate transfer belt 83 are second-transferred onto the recording sheet on the second transfer belt 84 by a second transfer device. With the second transfer belt 84 rotating, the recording sheet is transported to a fixing device 85, and the toner images are fixed on the recording sheet. Thereafter, the recording sheet is ejected onto a sheet ejection tray outside the image forming apparatus 3.

For example, the sheet feeding unit 90 feeds a particular recording sheet from one of sheet feeding cassettes 91 and 92 that store recording sheets of different sheet sizes. The recording sheet is then transported and supplied to the second transfer belt 84 by transport means 93 that includes various rollers.

As described above, the fifth embodiment includes the image reading device 1 described above in the first to fourth embodiments, providing the image forming apparatus 3 including the image reading device 1 that performs the image correction suitable for the recognition of the character information even if a character overlaps color content that is different in color from the character.

The image forming unit 80 is not limited to the above-described configuration that forms an image with the electrophotographic method, and may form an image with the inkjet method. Further, the image forming apparatus 3 is not limited to the MFP with at least two functions out of a copier function, a printer function, a scanner function, and a facsimile function, and may be any image forming apparatus such as a copier, a scanner, or a facsimile machine. For example, the image forming apparatus 3 may also be a printer that receives, via communication, image data generated by the image reading device 1 separated from the image forming apparatus 3 and prints the received image data.

The program executed on the image processing device of the above-described embodiments is provided as recorded on a computer-readable recording medium such as a compact disc-read only memory (CD-ROM), a flexible disc (FD), a CD-recordable (CD-R), or a digital versatile disc (DVD) in a file of an installable or executable format.

Further, the program executed on the image processing device of the embodiments may be stored in a computer connected to a network such as the Internet and be provided as downloaded via the network. The program executed on the image processing device of the embodiments may also be provided or distributed via a network such as the Internet.

Further, the program of the embodiments may be provided as previously stored in a memory such as a ROM.

The program executed on the image processing device of the embodiments is configured as a set of modules including the above-described units (e.g., the color area identification unit 311, the image correction unit 312, and the image output unit 313). As an actual hardware configuration, a CPU (processor) reads and executes the program from the above-described recording medium to load and generate the above-described units in a main storage device.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present disclosure relates to the following aspects, for example.

According to a first aspect, an image processing device includes a color area identification unit, an image correction unit, and an image output unit. The color area identification unit identifies a color area included in a read visible image and having a color different from a color of a character included in the read visible image. The image correction unit adjusts the color of the color area identified by the color area identification unit to be closer to a color of a background area forming a background of the character and the color area, to thereby correct the visible image to make the character included in the visible image recognizable. The image output unit outputs the corrected visible image corrected by the image correction unit.

According to a second aspect, in the image processing device of the first aspect, the image correction unit adjusts the color of the color area to be identical with the color of the background area.

According to a third aspect, in the image processing device of the first aspect, the image correction unit adjusts lightness of the color of the color area to be closer to lightness of the color of the background area.

According to a fourth aspect, in the image processing device of the first aspect, the image correction unit adjusts lightness of the color of the color area to be closer to lightness of white color.

According to a fifth aspect, in the image processing device of one of the first to fourth aspects, the color area identification unit identifies an area with a particular color as the color area.

According to a sixth aspect, in the image processing device of one of the first to fourth aspects, the color area identification unit identifies an area of a seal as the color area. The seal is a mark made by pressing a stamp.

According to a seventh aspect, in the image processing device of the sixth aspect, the color area identification unit identifies an area with a particular color as the area of the seal.

According to an eighth aspect, in the image processing device of the sixth aspect, the color area identification unit identifies an area formed with a particular color and a particular size as the area of the seal.

According to a ninth aspect, in the image processing device of one of the first to eighth aspects, the color area identification unit identifies the color area included in the visible image based on a learned model that has learned with the visible image including the color area and the character and a visible image of the color area.

According to a tenth aspect, the image processing device of one of the first to eighth aspects further includes a setting unit that sets the color of the color area identified by the color area identification unit.

According to an eleventh aspect, in the image processing device of one of the first to tenth aspects, the color area identification unit identifies the color area included in the visible image based on a read invisible image in addition to the read visible image.

According to a twelfth aspect, an image reading device includes a reading unit that reads a visible image and the image processing device of one of the first to tenth aspects.

According to a thirteenth aspect, an image reading device includes a reading unit that reads a visible image and an invisible image and the image processing device of the eleventh aspect.

According to a fourteenth aspect, an image forming apparatus includes a reading unit that reads a visible image, the image processing device of one of the first to tenth aspects, and an image forming unit that forms an image based on the corrected visible image output by the image processing device.

According to a fifteenth aspect, an image forming apparatus includes a reading unit that reads a visible image and an invisible image, the image processing device of the eleventh aspect, and an image forming unit that forms an image based on the corrected visible image output by the image processing device.

According to a sixteenth aspect, an information processing system includes the image processing device of one of the first to eleventh aspects and a character recognition unit that recognizes the character included in the corrected visible image output by the image processing device.

According to a seventeenth aspect, an image processing method executed on an image processing device includes identifying a color area included in a read visible image and having a color different from a color of a character included in the read visible image, adjusting the color of the color area identified by the identifying to be closer to a color of a background area forming a background of the character and the color area to correct the visible image to make the character included in the visible image recognizable, and outputting the corrected visible image corrected by the adjusting.

1. An image processing device comprising circuitry configured to
identify a color area included in a read visible image and having a color different from a color of a character included in the read visible image,
adjust the color of the identified color area to be closer to a color of a background area forming a background of the character and the color area to correct the visible image to make the character included in the visible image recognizable, and
output the corrected visible image.

2. The image processing device of claim 1, wherein the circuitry adjusts the color of the color area to be identical with the color of the background area.

3. The image processing device of claim 1, wherein the circuitry adjusts lightness of the color of the color area to be closer to lightness of the color of the background area.

4. The image processing device of claim 1, wherein the circuitry adjusts lightness of the color of the color area to be closer to lightness of white color.

5. The image processing device of claim 1, wherein the circuitry identifies an area with a particular color as the color area.

6. The image processing device of claim 1, wherein the circuitry identifies an area of a seal as the color area, the seal being a mark made by pressing a stamp.

7. The image processing device of claim 6, wherein the circuitry identifies an area with a particular color as the area of the seal.

8. The image processing device of claim 6, wherein the circuitry identifies an area formed with a particular color and a particular size as the area of the seal.

9. The image processing device of claim 1, wherein the circuitry identifies the color area included in the visible image based on a learned model that has learned with the visible image including the color area and the character and a visible image of the color area.

10. The image processing device of claim 1, wherein the circuitry is configured to allow a user to set the color of the color area.

11. The image processing device of claim 1, wherein the circuitry identifies the color area included in the visible image based on a read invisible image in addition to the read visible image.

12. An image reading device comprising:
a reading device to read a visible image; and
the image processing device of claim 1.

13. An image reading device comprising:
a reading device to read a visible image and an invisible image; and
the image processing device of claim 11.

14. An image forming apparatus comprising:
a reading device to read a visible image;
the image processing device of claim 1; and
an image forming device to form an image based on the corrected visible image output by the image processing device.

15. An image forming apparatus comprising:
a reading device to read a visible image and an invisible image;
the image processing device of claim 11; and
an image forming device to form an image based on the corrected visible image output by the image processing device.

16. An information processing system comprising:
the image processing device of claim 1; and
circuitry configured to recognize the character included in the corrected visible image output by the image processing device.

17. An image processing method executed on an image processing device, the image processing method comprising:
identifying a color area included in a read visible image and having a color different from a color of a character included in the read visible image;
adjusting the color of the identified color area to be closer to a color of a background area forming a background of the character and the color area to correct the visible image to make the character included in the visible image recognizable; and
outputting the corrected visible image.
